(19) United States
(12) Patent Application Publication
(10) Pub. No.: US 2024/0391408 A1
(43) Pub. Date: Nov. 28, 2024

(54) METHOD FOR STARTING UP AN ELECTRONIC CIRCUIT FOR AN AIRBAG SYSTEM

(71) Applicant: Elmos Semiconductor SE, Dortmund (DE)

(72) Inventors: Niron KAPOOR, Essen (DE); Fikret ABAZA, Duisburg (DE); Andre SUDHAUS, Recklinghausen (DE); Marco LIEDTKE, Hamm (DE); Frank GERSEMSKY, Recklinghausen (DE)

(21) Appl. No.: 18/673,402

(22) Filed: May 24, 2024

(30) Foreign Application Priority Data
May 25, 2023 (DE) 10 2023 113 861.8

(51) Int. Cl. B60R 21/017; B60R 21/01

(52) U.S. Cl. CPC B60R 21/017; B60R 2021/01286

(57) ABSTRACT

A method for starting up an electronic circuit for an airbag system is provided. The system includes a first transformer, a second transformer, a charging device, and an energy reserve device. A supply voltage is applied to the first transformer. The first transformer is controlled in a first start-up phase of the electronic circuit to output a first voltage. The charging device is controlled in a second start-up phase of the electronic circuit, such that the energy reserve device is brought to at least approximately 90% of the first voltage. The second transformer is controlled in a third start-up phase of the electronic circuit such that a second voltage that is higher than the first voltage is present at an output of the second transformer, and a third voltage that is higher than the first voltage is present at an output of the charging device.

### CROSS REFERENCE TO RELATED APPLICATIONS

This application claims benefit to German Patent Application No. DE 10 2023 113 861.8, filed on May 25, 2023, which is hereby incorporated by reference herein.

### FIELD

The invention relates, inter alia, to a method for starting up an electronic circuit for an airbag system.

### BACKGROUND

A variety of electronic circuits for igniting an airbag system, for example in a motor vehicle, are known.

An energy reserve device of an electronic circuit stores energy for igniting the airbag of the airbag system in the event of an accident. When the motor vehicle or the electronic circuit is started up, the energy reserve device has to be charged with energy. For this purpose, electronic circuits known to date have a voltage transformer in order, from a supply voltage that is present at the electronic circuit, to generate an increased voltage for charging the energy reserve device.

One disadvantage of methods known to date for starting up an electronic circuit for an airbag system is that a great deal of heat or power loss is generated. In addition, in electronic circuits known to date, it takes a long time before an energy reserve is available to the electronic circuit. Also, in electronic circuits known to date, the energy of the energy reserve device is used inefficiently in the event of a drop or failure of the supply voltage or, following a drop or failure of the supply voltage, the operation of the electronic circuit and/or of a microcontroller supplied with power by the electronic circuit is not able to be maintained for long.

### SUMMARY

In an embodiment, the present disclosure provides a method for starting up an electronic circuit for an airbag system, wherein the electronic circuit is designed to ignite an airbag of the airbag system, wherein, in the electronic circuit, an output of a first voltage transformer is connected to an input of a second voltage transformer, an output of the second voltage transformer is connected to an input of a charging device, and an output of the charging device is connected to an energy reserve device for storing an energy reserve for igniting the airbag, wherein the method comprises: applying a supply voltage to an input of the first voltage transformer; controlling the first voltage transformer, in a first start-up phase of the electronic circuit, such that the first voltage transformer outputs a first voltage value; controlling the charging device, in a second start-up phase of the electronic circuit, such that the energy reserve device is brought to at least approximately 90% of the first voltage value; and controlling the second voltage transformer, in a third start-up phase of the electronic circuit, such that a second voltage value that is higher than the first voltage value is present at the output of the second voltage transformer, and a third voltage value that is higher than the first voltage value is present at the output of the charging device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a first embodiment of the electronic circuit according to the invention;

FIG. 2 shows a schematic view of a second embodiment of the electronic circuit according to the invention; and

FIG. 3 shows a schematic sequence of the start-up phases of the electronic circuit according to the invention.

### DETAILED DESCRIPTION

In accordance with an embodiment, the present invention discloses a method for starting up an electronic circuit for an airbag system, which method exhibits low power loss and makes it possible to provide an energy reserve quickly in the event of a drop or failure of a supply voltage.

In accordance with another embodiment, the present invention provides a method for starting up an electronic circuit for an airbag system, wherein the electronic circuit is designed to ignite an airbag of the airbag system, wherein, in the electronic circuit, an output of a first voltage transformer is connected to an input of a second voltage transformer, an output of the second voltage transformer is connected to an input of a charging device, and an output of the charging device is connected to an energy reserve device for storing an energy reserve for igniting the airbag, wherein the method comprises the following steps: applying a supply voltage to the input of the first voltage transformer; controlling the first voltage transformer, in a first start-up phase of the electronic circuit, such that the first voltage transformer outputs a first voltage value; controlling the charging device, in a second start-up phase of the electronic circuit, such that the energy reserve device is brought to at least approx. 90%, in particular at least approx. 95%, preferably at least approx. 99%, particularly preferably approx. 100%, of the first voltage value; and controlling the second voltage transformer, in a third start-up phase of the electronic circuit, such that a second voltage value that is higher than the first voltage value, in particular higher than the third voltage value, is present at the output of the second voltage transformer, and a third voltage value that is higher than the first voltage value is present at the output of the charging device.

An exemplary advantage of this is that low power losses occur, in particular in the charging device, when the electronic circuit is started up. This makes it possible to design the electronic circuit to be particularly compact and to protect it better against excessive heating. In addition, the voltages are ramped up in succession, as it were, or started up sequentially and with at least temporarily reduced transformation ratios, which makes efficiency particularly high and renders the use of the available voltage or energy particularly efficient. The energy reserve device may thus be available quickly or at an early point in time. A microcontroller that is supplied with voltage by the electronic circuit may also be started up before the energy reserve device has been fully charged. The second voltage value in the third start-up phase is advantageously applied here so as to generate a voltage difference between the second voltage value and the third voltage value that is sufficient for operation or for the operation of the charging device, such that the charging device is able to be operated at low power loss. The second voltage value may be above the third output voltage value in a dynamic or variable manner. The second voltage transformer may be regulated such that the second voltage value is slightly above the third voltage value (for example by approx. 3%, approx. 5%, approx. 10%, approx. 1 V, approx. 3 V or approx. 5 V). This may also be controlled or regulated depending on the power loss of the charging device. The second voltage value or the third voltage value may be set adaptively, for example depending on the power loss in the charging device. In the second start-up phase, the output voltage of the second voltage transformer, that is to say the voltage value at the output of the second voltage transformer, may be a minimal amount higher or slightly higher (for example 1%, 2%, 3%, 5%, 10%, approx. 1 V, approx. 3 V or approx. 5 V) than the value of the voltage of the energy reserve device. In the second start-up phase, the second voltage transformer may be switched to pass-through mode (input voltage=output voltage) or the second voltage transformer may output a voltage at its output that is higher, for example 1%, 3%, 5% or 10% higher, than the first voltage value or the value of the voltage at its input. It is possible for the value of the second output voltage to be raised above the value of the third output voltage only to the extent it may be necessary for the operation of the charging device. This minimizes the power in the charging device.

In accordance with another embodiment, the present invention discloses an electronic circuit for igniting an airbag, in which the interruption of a voltage supply of the electronic circuit is able to be detected in a particularly reliable manner.

In accordance with another embodiment, the present invention provides an electronic circuit for igniting an airbag, wherein the electronic circuit comprises the following: a first voltage transformer, a second voltage transformer, a charging device, an energy reserve device for storing an energy reserve for igniting the airbag, wherein the output of the first voltage transformer is connected to an input of the second voltage transformer, wherein an output of the second voltage transformer is connected to an input of the charging device, wherein an output of the charging device is connected to the energy reserve device, and wherein the energy reserve device is connected to the output of the first voltage transformer via an autarchic switch.

An exemplary advantage of this is that the voltage made available by the energy reserve device in autarchy mode or in the event of interruption of the voltage supply at the first voltage transformer, for example in the event of an accident and the resulting breakage of the supply line, is not made available at a location at which the drop in the supply voltage is supposed to be detected and at which the drop in the supply voltage is supposed to trigger the changeover to autarchy mode, but rather, in autarchy mode, the voltage of the energy reserve device is made available at another location of the electronic circuit. By separating the position at which the supply voltage of the electronic circuit is monitored (for example input of the first voltage transformer) in order to detect a drop in the supply voltage or a problem with the supply voltage and the position at which the energy or voltage from the energy reserve device is made available in the event of an accident or an identified drop in the supply voltage (for example output of the first voltage transformer), a drop in the voltage that is made available to the electronic circuit to below a predetermined value (or the fact that the voltage is less than or equal to the predetermined value) is able to be identified particularly easily and reliably in technical terms. This makes it possible to change to autarchy mode in a particularly reliable manner, that is to say a change to autarchy mode actually takes place only if the voltage supply drops below a predefined value. It is thus possible to make a decision regarding a change to autarchy mode in a particularly reliable manner and to avoid unnecessary switching on and off of autarchy mode. In addition, it is advantageous for the second voltage transformer not to be subject to the required power or the power rating, since the first voltage transformer is able to make power available to further components (such as for example a fourth voltage transformer) and the second voltage transformer only provides the charging energy for the charging device or control currents for communication devices and/or control currents with regard to the ignition of the airbag. In particular, the second voltage transformer does not need to make available the energy for igniting the airbag. The energy for igniting the airbag comes from the energy reserve device. The electronic circuit may thereby be particularly compact and cost-effective.

In accordance with another embodiment, the present invention provides an airbag system comprising an airbag and an electronic circuit as described above for igniting the airbag.

Moreover, in accordance with another embodiment, the present invention discloses a method for providing a voltage by way of an electronic circuit, which method is able to make voltage available to further components for a particularly long time in the event of interruption of a voltage supply of the electronic circuit, by way of the stored energy in the energy reserve device of the electronic circuit.

In accordance with another embodiment, the present invention provides a method for providing a voltage by way of an electronic circuit, in particular by way of an electronic circuit as described above, wherein the electronic circuit is designed to ignite an airbag, wherein, in the electronic circuit, an output of a first voltage transformer is connected to an input of a second voltage transformer, an output of the second voltage transformer is connected to an input of a charging device, an output of the charging device is connected to an energy reserve device for storing an energy reserve for igniting the airbag, and the energy reserve device is connected to the input of the second voltage transformer via an autarchic switch, wherein the method comprises the following steps: identifying whether a voltage that is present at the input of the first voltage transformer is below a predefined value; and, if it has been identified that the voltage at the input of the first voltage transformer is below the predefined value, switching the autarchic switch to pass-through mode so that the energy reserve device is electrically connected to the input of the second voltage transformer, and disabling the charging device.

In some embodiments, an advantage of this is that the energy stored in the energy reserve device of the electronic circuit is able to trigger the ignition of the airbag and/or supply energy to other external components, for example data memories for storing accident information and/or communication devices, for a particularly long interval following the drop in the voltage at the input of the first voltage transformer and thus also at the output of the first voltage transformer, in particular due to the provision of the power supply by the second voltage transformer. This additionally makes it possible to design the energy reserve device in a particularly compact manner, since the energy of the energy reserve device is used particularly efficiently. In addition, it is possible for the electronic circuit to provide a voltage that is higher than the voltage present at the energy reserve device, advantageously at the output of the second voltage transformer. Thus, even after a drop in the voltage at the energy reserve device, it is still possible to provide a sufficient voltage to external components. If it has been identified that the voltage at the input of the first voltage transformer is equal to the predefined value or greater than the predefined value, the autarchic switch is normally in blocking mode or is blocked. In this case, the disabled state of the charging device is typically no longer dependent on the voltage at the input of the first voltage transformer.

According to one embodiment of the method for starting up an electronic circuit, the charging device is disabled in the first start-up phase of the electronic circuit. One advantage of this is that no energy flows to the energy reserve device in the first start-up phase, and so the voltages, in particular the voltage at the output of the first voltage transformer, is able to be built up particularly quickly in order to start up the electronic circuit. In the first start-up phase, the second voltage transformer may be switched to pass-through mode. It is also conceivable for the second voltage transformer to be switched on in the first start-up phase and to output a higher voltage at its output than is present at its input. Thus, in the first start-up phase, a sufficient voltage may already be output for provision for communication and/or sensors, for example.

According to one embodiment of the method for starting up an electronic circuit, in the second start-up phase of the electronic circuit, the current at the output of the charging device is regulated such that the power loss of the charging device, in particular of the electronic circuit, does not exceed a predetermined first value. This ensures that the energy reserve device is charged particularly efficiently. By way of example, the power loss may also be kept within permissible thermal operating limits. In addition, the available energy is used particularly efficiently and the generation of heat at or in the charging device is reduced. The electronic circuit may thereby be designed in a particularly compact manner.

According to one embodiment of the method for starting up an electronic circuit, the second voltage transformer and/or the charging device, in the second and/or third start-up phase, are/is controlled such that the second voltage value is higher, in particular at most 10% or at most 5 V higher, preferably at most 5% or at most 3 V higher, particularly preferably at most 1% or at most 1 V higher, than the third voltage value. One advantage of this is that power losses are particularly low. In this case, the second voltage transformer and/or the charging device, in the second and/or third start-up phase, may be controlled such that the second voltage value is always, or always remains, less than a predefined maximum voltage value.

According to one embodiment of the method for starting up an electronic circuit, in the second start-up phase of the electronic circuit, the charging device is controlled such that the energy reserve device is substantially fully charged within an interval that is less than or equal to a predefined maximum time value. One advantage of this is that it is ensured that the energy reserve device, in particular despite limited power loss or limitation of the maximum permissible power loss, is charged quickly, so that the electronic circuit is ready to ignite the airbag shortly after start-up of the electronic circuit. This makes it possible in particular to comply with legal or regulatory requirements.

According to one embodiment of the method for starting up an electronic circuit, in the third start-up phase, the charging device is controlled such that the power loss of the charging device, in particular of the electronic circuit, does not exceed a predetermined second value. One advantage of this is that the power losses at the charging device are low, in particular due to the dynamic adjustment of the output or of the voltage value at the output of the second voltage transformer with reference to the output voltage and/or temperature of the charging device. This reliably prevents (thermal) overloading of the charging device, and the charging time of the energy reserve device is additionally reduced. In addition, the electronic circuit may be designed in a compact manner, since only a small amount of heat is generated or the reduced power loss of the circuit or charging circuit at least temporarily reduces the power at the output of the first voltage transformer. In addition to the charging device, the second voltage transformer may also be controlled here such that the power loss of the charging device, in particular of the electronic circuit, does not exceed a predetermined second value.

According to one embodiment of the method for starting up an electronic circuit, the charging device is controlled such that the current at the output of the charging device is dependent on the temperature of the electronic circuit and/or dependent on the temperature of the energy reserve device and/or dependent on the temperature of the charging device and/or dependent on the temperature of the first voltage transformer and/or dependent on the temperature of the second voltage transformer. One advantage of this adaptive current control is that, on the one hand, the energy reserve device is charged very quickly and, on the other hand, any overheating of or damage to the energy reserve device or the electronic circuit or the charging device is reliably prevented. The energy reserve device is thus charged particularly efficiently. The energy reserve device may therefore be charged as quickly as possible without damaging the charging device or the electronic circuit or the energy reserve device.

According to one embodiment of the electronic circuit, the output of the second voltage transformer is connected to an ignition device for the airbag. One advantage of this is that the electronic circuit is of particularly simple design in technical terms. In addition, a sufficient voltage for igniting the airbags is able to be made available in a reliable manner for a particularly long time even in autarchy mode of the ignition device, that is to say when the electronic circuit or the first voltage transformer is no longer being supplied externally with a sufficient voltage. Even if the voltage of the energy reserve device decreases, the second voltage transformer is able to increase the voltage or output a higher voltage at its output than is present at its input. The ignition device is thereby then supplied with a sufficiently high voltage by the electronic circuit even if a sufficient voltage for a direct or immediate supply of power to the ignition device, that is to say not via a voltage transformer, is no longer present at the energy reserve device. The availability of the function of the ignition device is thereby increased.

According to one embodiment of the electronic circuit, the output of the first voltage transformer is connected to a fourth voltage transformer, in particular a step-down converter, for providing an external provision voltage. One advantage of using the output voltage of the first voltage transformer as a power supply for the fourth voltage transformer is that it is possible, by selecting the voltage at the output of the first voltage transformer with reduced power losses (compared to using the output voltages of the second voltage transformer or of the charging device), to generate an external provision voltage. Since the voltage at the output of the first voltage transformer is not very high, the voltage does not need to be reduced or stepped down much in the case of a step-down converter as fourth voltage transformer. Particularly little heat is thereby generated, meaning that the electronic circuit is able to be designed in a particularly compact manner. The external provision voltage may for example be made available directly or indirectly to a microcontroller that initiates or starts the charging of the energy reserve device, or the microcontroller may be electrically connected to the output of the fourth voltage transformer. The microcontroller is able to control the first voltage transformer, the second voltage transformer and the charging device. The microcontroller is also able to trigger or control the ignition of the airbag.

According to one embodiment of the electronic circuit, the output of the second voltage transformer is connected to a functional assembly for a motor vehicle, in particular to a PSI5 communication device. One advantage of this is that the functional assembly, in particular a communication device and/or a controller of an ignition device for igniting the airbag and/or a controller of a third airbag safety switch as known from the prior art, is able to be supplied reliably with energy or voltage. In particular, even in autarchy mode, that is to say when the electronic circuit is no longer provided with any or with sufficient external energy or voltage (for example due to an accident), the functional assembly, for example the communication device, is able to be supplied with sufficient voltage for its functionality by the electronic circuit. Therefore, in the event of an accident, communication within the motor vehicle is able to be maintained for a particularly long time. Due to the fact that the second voltage transformer is able to increase or increases the voltage of the energy reserve device, the communication device may thus still be supplied with sufficient voltage even when the voltage of the energy reserve device is low or no longer sufficient.

According to one embodiment of the electronic circuit, the output of the first voltage transformer is connected to a communication device for a motor vehicle, in particular to a PSI5 communication device. One advantage of this is that the communication device is able to be supplied with energy or voltage early after the start-up of the electronic circuit.

According to one embodiment of the method for providing a voltage by way of an electronic circuit, if it has been identified that the voltage that is present at the input of the first voltage transformer is below a predefined value, the value of the voltage at the output of the second voltage transformer is set to a different value, in particular a lower value, than the second voltage value, wherein the second voltage value is the value of the voltage that is present at the output of the second voltage transformer if it has been identified that the voltage that is present at the input of the first voltage transformer is not below the predefined value. One advantage of this is that a sufficient voltage for supplying power to components, for example a communication device and/or an ignition device for triggering the airbag, is able to be made available for a particularly long time at the output of the second voltage transformer in autarchy mode, that is to say if it has been identified that the voltage at the input of the first voltage transformer is below the predefined value, by way of the energy of the energy reserve device. This means that, by adjusting the value of the voltage at the output of the second voltage transformer, the energy of the energy reserve device is handled in a particularly efficient or sparing manner if it has been identified that the voltage at the input of the first voltage transformer is below the predefined value. In autarchy mode, the second voltage transformer boosts the voltage at its input only to the extent it may be necessary. This avoids excessively great or excessively fast energy consumption of the energy of the energy reserve device and reduces power losses in the electronic circuit.

A voltage transformer may be understood to mean in particular a device or a component that is able to convert a DC voltage into another DC voltage (DC voltage transformer, DC-DC converter). Of course, a voltage transformer may also be switched to pass-through mode, such that the voltage at the input is equal to the voltage at the output. It is conceivable for the voltage transformer to be able to output a higher voltage or a lower voltage at its output than at its input.

A charging device may be understood to mean in particular a power source. The charging device or power source may be controllable. It is possible for the charging device to reduce the voltage present at its input, in particular to reduce it slightly (for example 1%, 3%, 5%, 7% or 10%), and to output this reduced voltage at its output. The output voltage may be regulated or controlled. The charging device may in particular be a step-down converter or buck converter. The charging device may comprise or be a SEPIC (single-ended primary inductance converter) and/or a buck converter. It is conceivable for the charging device to be a third voltage transformer.

The fourth voltage transformer may in particular be a step-down converter or buck converter or SEPIC (single-ended primary inductance converter).

The first voltage transformer, the second voltage transformer, the charging device and the autarchic switch may be part of an integrated circuit. The fourth voltage transformer may also be part of the integrated circuit. It is possible for parts of the first voltage transformer, of the second voltage transformer, of the charging device, of the autarchic switch and/or of the fourth voltage transformer to be part of an integrated circuit, while other parts or components thereof (for example coils and/or inductors) are not part of the integrated circuit.

The start-up or the three start-up phases of the electronic circuit may be carried out in particular when the electronic circuit is started up or supplied with a supply voltage at the input of the first voltage transformer (after no supply voltage was previously present at the input of the first voltage transformer). This may take place in particular when the motor vehicle or the electronics of the motor vehicle are started up.

The start-up time of the fourth voltage transformer, that is to say the time at which the fourth voltage transformer is switched on, is in this case preferably independent of the beginning of the second start-up phase and independent of the beginning of the third start-up phase. Advantageously, the start-up time of the fourth voltage transformer is in the first start-up phase or the fourth voltage transformer is started up during the first start-up phase.

Power loss may be understood to mean in particular power that is taken up by the respective component, for example the voltage transformer, but that is not output in the form of electric power, but rather is output in the form of heat, for example.

The energy reserve device may comprise a capacitor or may be a capacitor. The term “substantially fully charged” with respect to the energy reserve device may be understood to mean that the maximum storable energy is present in the energy reserve device, for example 99.9%, 99.0% or 95.0% of the maximum storable energy. By way of example, the capacitor is substantially fully charged when 99.9%, 99.0%, or 95.0% of the maximum capacitance value is present in the capacitor.

An autarchic switch may be understood to mean in particular a switch that is switched on from a blocking state or switched to pass-through mode when the supply voltage of the electronic circuit, which is made available externally (for example from the battery of the motor vehicle) to the electronic circuit, drops to below a predetermined value or drops to (almost) zero. In this case, it may be assumed that the battery or the supply line to the electronic circuit has been physically interrupted (for example broken) or that the battery has failed. This state is also called autarchy mode. In other words, in autarchy mode, the electronic circuit is no longer supplied, or no longer supplied to a sufficient extent, externally with energy or voltage, but rather the energy reserve device has to supply the electronic circuit or parts thereof with energy or voltage.

The temperature of the electronic circuit may be recorded at a specific location. It is also possible for the temperature to be recorded at multiple locations of the electronic circuit and for the temperature of the electronic circuit to be determined as the average or weighted average of the recorded temperatures.

An ignition device or ignition controller may be understood to mean in particular a constellation of two circuit breakers (known as high-side and low-side switches) above and below an ignition element, for example an ignition pill or inductive ignition mechanism (known as a low-energy actuator, LEA for short), as well as the drive means for these circuit breakers.

A third safety switch may be understood to mean in particular an arrangement consisting of a third circuit breaker, arranged in series with the two circuit breakers of the ignition device and the ignition element, in combination with the corresponding drive means for this third circuit breaker. This third safety switch is particularly suitable for redundantly safeguarding against the unintentional provision of ignition energy to the ignition element. Since this third safety switch may be implemented in particular as a power transistor with a threshold voltage, it is advantageous to provide a voltage above the voltage of the energy reserve device for the purpose of driving the power semiconductor.

A PSI5 communication device may be understood to mean in particular a communication device having a PSI5 interface (Peripheral Sensor Interface 5).

Preferred embodiments will become apparent from the dependent claims. The invention is explained in more detail below with reference to drawings of exemplary embodiments.

The following description uses the same reference numerals for identical and functionally identical parts.

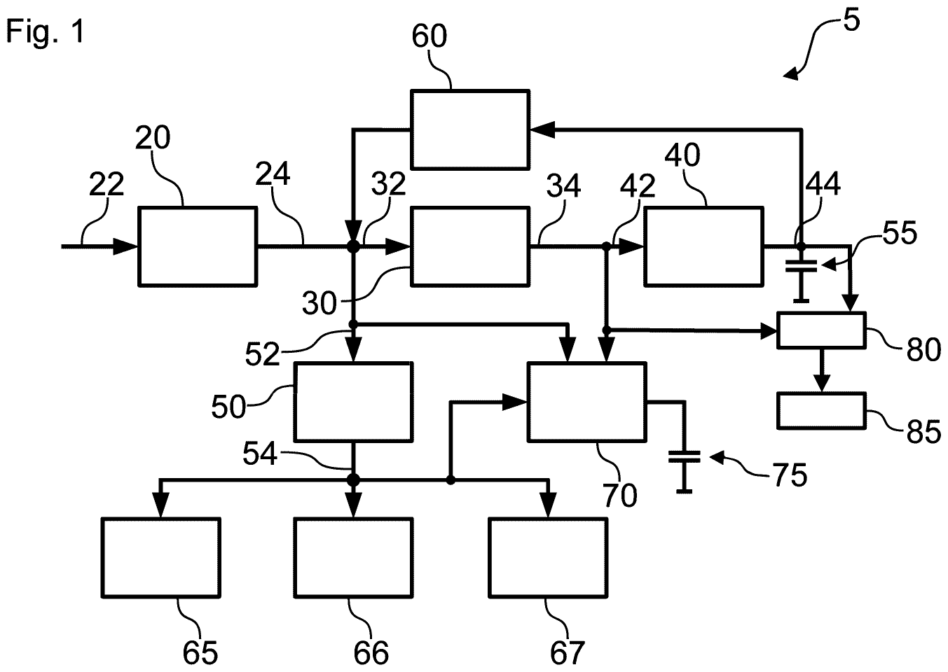

FIG. 1 shows a schematic view of a first embodiment of the electronic circuit 5 according to the invention. The electronic circuit 5 is designed to ignite an airbag 85. The electronic circuit 5 may be arranged in a motor vehicle, for example a car, truck, motorcycle or bus.

The electronic circuit 5 comprises a first voltage transformer 20, a second voltage transformer 30 and a charging device 40. The input 22 of the first voltage transformer 20 is connected to a voltage supply, for example a battery, or is able to be electrically connected to the battery when the motor vehicle is started up. The output 24 of the first voltage transformer 20 is connected to the input 32 of the second voltage transformer 30. The output 34 of the second voltage transformer 30 is connected to the input 42 of a charging device 40.

The electronic circuit 5 comprises an energy reserve device 55. It is also conceivable for the electronic circuit 5 to have more than one energy reserve device 55, for example two or three energy reserve devices. The energy reserve device 55 is electrically connected to the output 44 of the charging device 40. The energy reserve device 55 may for example comprise or be a capacitor.

The output 44 of the charging device 40 is connected to the output 24 of the first voltage transformer 20 or to the input 32 of the second voltage transformer 30 via a switchable autarchic switch 60. The autarchic switch 60 is able to be switched to pass-through mode or to blocking mode. The energy reserve device 55 is thus likewise connected to the output 24 of the first voltage transformer 20 or to the input 32 of the second voltage transformer 30 via the autarchic switch 60.

The output 24 of the first voltage transformer 20 or the input 32 of the second voltage transformer 30 is connected to a fourth voltage transformer 50. The fourth voltage transformer 50 may in particular be a step-down converter or buck converter. The fourth voltage transformer 50 makes a voltage or energy available to external components 65-67. One of these external components 65-67 may be a microcontroller that controls the ignition of the airbag 85 and/or the charging of the energy reserve device 55. The microcontroller is able to control the voltage transformers 20, 30, 40, 50 of the electronic circuit 5. The output 54 of the fourth voltage transformer 50 has a fourth voltage value when the output 24 of the first voltage transformer 20 has the first voltage value. Another possibility is for the external components 65-67 to comprise or be sensor devices for detecting seat occupancy of the motor vehicle and/or for detecting accidents and/or for recording a temperature and/or further voltage transformers.

The input 32 of the second voltage transformer 30 may be connected to a communication device 70, in particular a PSI5 communication device. The output 54 of the fourth voltage transformer 50 may also, as an alternative or in addition, be connected to the PSI5 communication device 70. The output 34 of the second voltage transformer 34 may also be connected to the communication device 70.

The ignition device 80 for the airbag 85 is connected both to the energy reserve device 55 and to the input of the PSI5 communication device 70 and/or to the output 34 of the second voltage transformer 30 and/or to the input 32 of the second voltage transformer 30. The ignition device 80 for the airbag 85 may have a MOSFET. The ignition device 80 may also be connected to the input 22 of the first voltage transformer 20.

The autarchic switch 60, which is able to connect the energy reserve device 55 to the input 32 of the second voltage transformer 30, is blocked in the normal state, that is to say when the supply voltage is present at the input 22 of the first voltage transformer 20.

The voltage that is output from the first voltage transformer 20 or is present at the output 24 of the first voltage transformer 20 (first voltage value) is, on the one hand, high enough to remain as stable as possible even in the event of fluctuations in the supply voltage and to supply the further components with sufficient voltage, and, on the other hand, low enough to keep the power loss of the electronic circuit as low as possible due to reduced transformation ratios between input and output. The first voltage value may be variable or changeable.

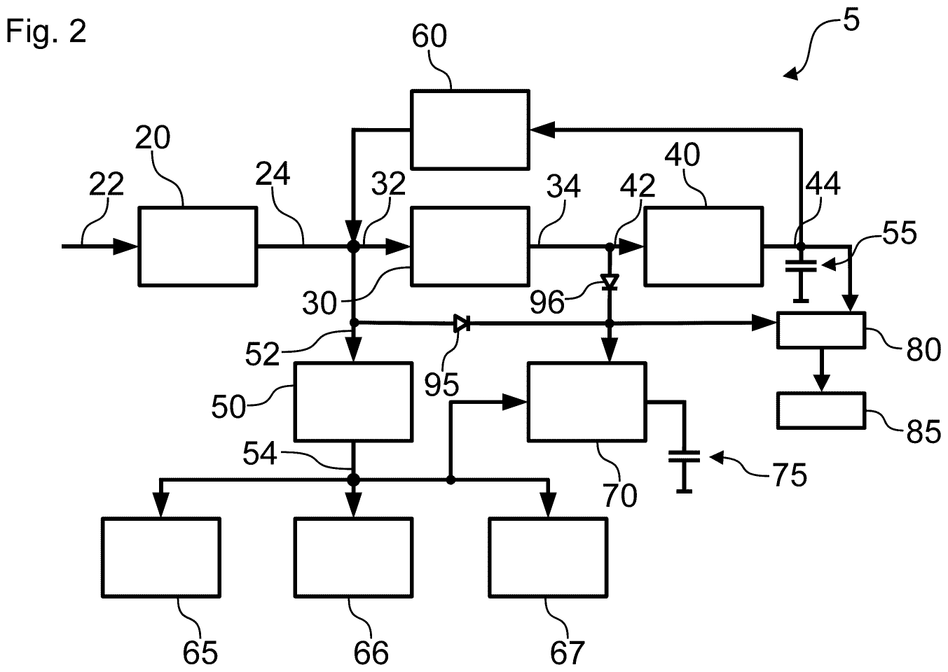

FIG. 2 shows a schematic view of a second embodiment of the electronic circuit according to the invention.

The second embodiment differs from the first embodiment in terms of the following aspects:

A first diode 95 is arranged between the input 32 of the second voltage transformer 30 and the communication device 70 and has its forward direction from the input 32 of the second voltage transformer 30 to the PSI5 communication device 70. The input 42 of the charging device 40 or the output 34 of the second voltage transformer 30 is connected to the PSI5 communication device 70. A second diode 96 is arranged between the input 42 of the charging device 40 or the output 34 of the second voltage transformer 30 and the PSI5 communication device 70. The second diode 96 has its forward direction from the input 42 of the charging device 40 to the PSI5 communication device 70.

Both the ignition device 80 for the airbag 85 and the communication device 70 are thereby supplied by two voltage sources or connected to two voltages. This increases the reliability of the voltage supply.

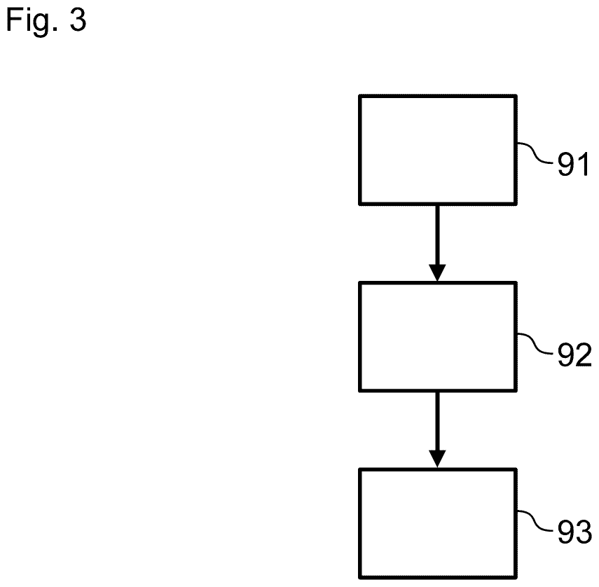

FIG. 3 shows a schematic sequence of the start-up phases 91, 92, 93 of the electronic circuit 5 according to the invention.

The sequence of the start-up phases may take place in an electronic circuit 5 according to the first embodiment or according to the second embodiment or else in an electronic circuit with a different design.

When starting up or in order to start up the electronic circuit 5, that is to say when a voltage or the supply voltage is applied to the input 22 of the first voltage transformer 20 and/or a corresponding control signal is applied to wake up the electronic circuit, the method for starting up the electronic circuit 5 is started or the electronic circuit 5 is started up. The method for starting up the electronic circuit 5 comprises a first start-up phase 91, followed by a second start-up phase 92 and then a third start-up phase 93.

In the first start-up phase 91, the first voltage transformer 20 powers up, that is to say the first voltage transformer 20 boosts the (supply) voltage present at its input 22 and outputs a voltage having a first voltage value. This first voltage value is selected such that, on the one hand, the voltage is high enough to be kept stable even in the event of changes in the voltage at the input 22 of the first voltage transformer 20 and to supply the second voltage transformer 30 and/or the fourth voltage transformer 50 with a sufficient voltage or with a voltage sufficient for their functionality. At the same time, the first voltage value is selected to be so low that the power loss of the integrated circuit 5 or of the first voltage transformer 20 and of the fourth voltage transformer 50 is as low as possible.

The charging device 40 remains disabled in the first start-up phase 91, that is to say no current flows from the first voltage transformer 20 to the energy reserve device 55. Sufficient voltage is thus available to the external components 65-67 earlier compared to the situation in which the energy reserve device 55 would already be charged in the first start-up phase 91. At the end of the first start-up phase 91, the microcontroller, which is supplied with voltage via the fourth voltage transformer 50, supplies the ignition device 80 for the airbag 85 and the PSI5 communication device 70 with sufficient voltage for their full functionality. The microcontroller is started up and carries out initialization of the microcontroller and initialization and diagnosis of the airbag system. In the first start-up phase 91, the second voltage transformer 30 may be switched to pass-through mode. The communication device 70 is connected to a synchronization capacitor 75, which stores and makes available energy for synchronization pulses.

After the first start-up phase 91, the second start-up phase 92 begins. In the second start-up phase 92, the second voltage transformer 30 may be kept in pass-through mode, that is to say it does not boost the voltage at its input 32, but rather the voltage at its output 34 is essentially the voltage at its input 32, in particular when a step-up converter or boost converter is used as second voltage transformer 30. It is possible for the second voltage transformer 30, in the second start-up phase 91, to output a somewhat higher voltage (for example 1%, 3%, 5% or 10% higher or approx. 1 V, approx. 3 V or approx. 5 V higher) than is present at the energy reserve device 55. The charging device 40 is switched on. The charging device 40 or the current at the output 44 of the charging device 40 is set adaptively such that the power loss of the electronic circuit 5 or of the charging device 40 is less than a first predefined value, and it is nevertheless ensured that the interval until the energy reserve device 55 is fully charged does not exceed a first predefined time value or a predefined maximum time value (for example 2 seconds or 3 seconds). Power loss peaks are thereby avoided or reduced. This increases the longevity and reliability of the electronic circuit 5 and allows the circuit 5 to be operated close to its permissible temperature limits, but not outside its permissible temperature limits. At the end of the second start-up phase 92, the energy reserve device 55 is charged to the voltage of the first voltage value, that is to say to the voltage at the output 24 of the first voltage transformer 20 or the voltage at the output 34 of the second voltage transformer 30 (since the second voltage transformer 30 is able to be kept in pass-through mode). It is also possible, at the end of the second start-up phase 92, for the energy reserve device 55 to be charged to at least 90%, preferably at least 95%, particularly preferably at least 99%, of the voltage of the first voltage value, that is to say to at least 90%, preferably at least 95%, particularly preferably at least 99%, of the voltage at output 24 of the first voltage transformer 20 or of the voltage at the output 34 of the second voltage transformer 30.

This is followed by the third start-up phase 93. In the third start-up phase 93, the second voltage transformer 30 is activated or switched on and boosts the voltage at its input 32. In particular, in the third start-up phase 93, the second voltage transformer 30 boosts the voltage at its input not just slightly, that is to say boosts it by more than 1%, more than 3%, more than 5% or more than 10% or more than approx. 1 V, approx. 3 V or approx. 5 V. The voltage at the output 34 of the second voltage transformer 30 then moves upwards or increases and at the same time the voltage at the output 44 of the charging device 40 increases. A third voltage value is present at the output 44 of the charging device 40 at the end of the third start-up phase 93. The third voltage value is higher than the first voltage value.

The third voltage value is typically lower than the second voltage value. This means that the voltage drops across the charging device 40. This usually applies during charging of the energy reserve device 55. At the end of the third start-up phase, the third voltage value may be equal to or almost equal to the second voltage value, or the value of the voltage at the input 42 of the charging device 40 may be almost equal to or substantially equal or identical to the value of the voltage at the output 44 of the charging device 40.

The current at the output 44 of the charging device 40 may be controlled or regulated depending on the temperature of the charging device 40 and/or depending on the temperature of the electronic circuit 5 and/or depending on the temperature of the energy reserve device 55 and/or depending on the temperature of the first voltage transformer 20 or of the second voltage transformer 30. If the temperature is below a first predefined temperature value, it is possible to set a high current at the output 44 of the charging device 40. In the event of a temperature greater than or equal to the first temperature value, the current at the output 44 of the charging device 40 may be reduced or set lower. It is possible for there to be multiple temperature threshold values and for the current to be set to discrete values depending thereon. It is also conceivable for a linear relationship between temperature and current to be set. Also possible here is a proportionality factor that uses a relationship between the current temperature and the maximum permitted or a predefined maximum value to set the current or the value of the current at the output 44 of the charging device 40. Excessively high thermal loading that could lead to damage to and/or shortening of the lifetime of the electronic circuit 5 or of one of its components is thereby reliably prevented. At the same time, this adaptive current control ensures that the energy reserve device 55 is fully charged with energy in the shortest possible time.

The voltage drop across the charging device 40 is controlled such that it is as low as possible, such that power losses at the charging device 40 are largely avoided and overloading of the charging device 40 is avoided.

The third start-up phase 93 is then finished, and the start-up process of the electronic circuit 5 is complete.

In normal operation of the electronic circuit 5, for example after passing through the three start-up phases or even during same, the voltage at the input 22 of the first voltage transformer 20 is monitored or repeatedly detected. This may be carried out for example by the microcontroller and/or the electronic circuit 5. The microcontroller might not be part of the electronic circuit 5, that is to say the microcontroller may be an external element with respect to the electronic circuit 5. It is also conceivable for the microcontroller to be part of the electronic circuit. Since the voltage at the input 22 of the first voltage transformer 20 is unaffected by the energy reserve device 55, that is to say the energy reserve device 55 is not connected to the input 22 of the first voltage transformer 20 (but rather to the output 24 of the first voltage transformer 20) even in autarchy mode, the voltage at the input 22 of the first voltage transformer 20 is able to be monitored particularly reliably, and it is possible to identify in a particularly precise manner whether the voltage at the input 22 of the first voltage transformer 20 is less than or equal to the first predefined voltage value.

If the voltage at the input 22 of the first voltage transformer 20 falls below or reaches a first predefined value, for example due to breakage of the line from the battery to the input 22 of the first voltage transformer 20, for example as a result of an accident, the electronic circuit 5 is put into autarchy mode. This is independent of the start-up or the three start-up phases of the electronic circuit 5 and interrupts the sequence of the three start-up phases where applicable. In autarchy mode, the autarchic switch 60 is switched to pass-through mode such that the voltage at the input 32 of the second voltage transformer 30 increases from the first voltage value preferably to the third voltage value that is present at the energy reserve device 55. In autarchy mode, the charging device 40 is disabled. This prevents a circulation of the energy from the energy reserve device 55 and the power loss that typically results therefrom. The second voltage transformer 30 remains switched on or active in autarchy mode. It is possible for the voltage at the output 34 of the second voltage transformer 30 to be lowered compared to normal mode, that is to say for the second voltage transformer 30 to be controlled such that the voltage at the output 34 of the second voltage transformer 30 drops from the second voltage value (which is present at the output of the second voltage transformer 30, while the voltage at the input of the first voltage transformer 20 is above the first predefined value) to a lower value. This lower value is still high enough both to supply the PSI5 communication device 70 with sufficient voltage and to supply the ignition device 80 with sufficient voltage, for example.

As soon as autarchy mode is terminated when the input voltage 22 at the first voltage transformer 20 exceeds a first predefined value, the electronic circuit 5 re-enters the sequence of start-up phases, preferably beginning in the second start-up phase. This second start-up phase may be skipped in favour of the third start-up phase, provided that the value of the voltage of the energy reserve device 55 meets the described requirements for entry into the third start-up phase, that is to say in particular the voltage at the energy reserve device 55 corresponds to the first voltage value. This may be controlled by the microcontroller.

In autarchy mode, it is ensured that, even with decreasing energy in the energy reserve device 55, which now has to supply the microcontroller, the PSI5 communication device 70 and the ignition device 80 with energy, the most important functions are maintained. These may likewise include storing information in relation to the motor vehicle during an accident and possibly immediately after an accident. For this purpose, for example, it is possible to perform frequency derating of the communication device 70. As an alternative or in addition, unnecessary functions may be switched to standby or shut down. Current consumption or energy consumption is thereby minimized, such that the energy stored in the energy reserve device 55 maintains the safety-relevant functionality of the microcontroller, of the PSI5 communication device 70 and of the ignition device 80 for the airbag 85 for as long as possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

5 Electronic circuit
20 First voltage transformer
22 Input of the first voltage transformer
24 Output of the first voltage transformer
30 Second voltage transformer
32 Input of the second voltage transformer
34 Output of the second voltage transformer
40 Charging device
42 Input of the charging device
44 Output of the charging device
50 Fourth voltage transformer
52 Input of the fourth voltage transformer
54 Output of the fourth voltage transformer
55 Energy reserve device (capacitor)
60 Autarchic switch
65 First external component
66 Second external component
67 Third external component
70 Communication device
75 Capacitor for communication device
80 Ignition device for the airbag
85 Airbag
91 First start-up phase
92 Second start-up phase
93 Third start-up phase
95 First diode
96 Second diode

1. A method for starting up an electronic circuit for an airbag system, wherein the electronic circuit is configured to ignite an airbag of the airbag system, wherein, in the electronic circuit, an output of a first voltage transformer is connected to an input of a second voltage transformer, an output of the second voltage transformer is connected to an input of a charging device, and an output of the charging device is connected to an energy reserve device for storing an energy reserve for igniting the airbag, the method comprising:
applying a supply voltage to an input of the first voltage transformer;
controlling the first voltage transformer, in a first start-up phase of the electronic circuit, such that the first voltage transformer outputs a first voltage value;
controlling the charging device, in a second start-up phase of the electronic circuit, such that the energy reserve device is brought to at least approximately 90% of the first voltage value; and
controlling the second voltage transformer, in a third start-up phase of the electronic circuit, such that a second voltage value that is higher than the first voltage value is present at the output of the second voltage transformer, and a third voltage value that is higher than the first voltage value is present at the output of the charging device.

2. The method according to claim 1, wherein,
in the first start-up phase of the electronic circuit, the charging device is disabled.

3. The method according to claim 1, wherein,
in the second start-up phase of the electronic circuit, a current at the output of the charging device is regulated such that a power loss of the charging device does not exceed a predetermined first value.

4. The method according to claim 1, wherein,
the second voltage transformer and/or the charging device, in the second start-up phase and/or the third start-up phase, are/is controlled such that the second voltage value is higher than the third voltage value.

5. The method according to claim 1, wherein,
in the second start-up phase of the electronic circuit, the charging device is controlled such that the energy reserve device is substantially fully charged within an interval that is less than or equal to a predefined maximum time value.

6. The method according to claim 1, wherein,
in the third start-up phase, the charging device is controlled such that a power loss of the charging device does not exceed a predetermined second value.

7. The method according to claim 1, wherein,
the charging device is controlled such that current at the output of the charging device is dependent on a temperature of the electronic circuit and/or dependent on the temperature of the energy reserve device and/or dependent on the temperature of the charging device and/or dependent on the temperature of the first voltage transformer and/or dependent on the temperature of the second voltage transformer.

8. An electronic circuit for igniting an airbag, wherein the electronic circuit comprises:
a first voltage transformer,
a second voltage transformer,
a charging device,
an energy reserve device for storing an energy reserve for igniting the airbag,
wherein an output of the first voltage transformer is connected to an input of the second voltage transformer,
wherein an output of the second voltage transformer is connected to an input of the charging device,
wherein an output of the charging device is connected to the energy reserve device, and
wherein the energy reserve device is connected to the output of the first voltage transformer via an autarchic switch.

9. The electronic circuit according to claim 8, wherein
the output of the second voltage transformer is connected to an ignition device for the airbag.

10. The electronic circuit according to claim 8, wherein
the output of the first voltage transformer is connected to a fourth voltage transformer for providing an external provision voltage.

11. The electronic circuit according to claim 8, wherein
the output of the second voltage transformer is connected to a communication device for a motor vehicle.

12. The electronic circuit according to claim 8, wherein
the output of the first voltage transformer is connected to a communication device for a motor vehicle.

13. An airbag system comprising:
an airbag, and
the electronic circuit for igniting the airbag according to claim 8.

14. A motor vehicle comprising:
the airbag system according to claim 13.

15. A method for providing a voltage by way of an electronic circuit, wherein the electronic circuit is designed to ignite an airbag,
wherein, in the electronic circuit, an output of a first voltage transformer is connected to an input of a second voltage transformer, an output of the second voltage transformer is connected to an input of a charging device, an output of the charging device is connected to an energy reserve device for storing an energy reserve for igniting the airbag, and the energy reserve device is connected to the input of the second voltage transformer via the autarchic switch,
wherein the method comprises the following steps:
identifying whether a voltage that is present at an input of the first voltage transformer is below a predefined value; and
if it has been identified that the voltage at the input of the first voltage transformer is below the predefined value, switching the autarchic switch to pass-through mode so that the energy reserve device is electrically connected to the input of the second voltage transformer, and disabling the charging device.

16. The method according to claim 15, wherein,
if it has been identified that the voltage that is present at the input of the first voltage transformer is below the predefined value, a value of the voltage at the output of the second voltage transformer is set to a different value than the second voltage value,
wherein the second voltage value is the value of the voltage that is present at the output of the second voltage transformer if it has been identified that the voltage that is present at the input of the first voltage transformer is not below the predefined value.

17. The method according to claim 1, wherein the energy reserve is brought to at least approximately 95% of the first voltage value.

18. The method according to claim 1, wherein the energy reserve is brought to at least approximately 99% of the first voltage value.

19. The method according to claim 4, wherein the second voltage value is at most 5% or at most 3 V higher than the third voltage value.

20. The method according to claim 4, wherein the second voltage value is at most 1% or at most 1 V higher than the third voltage value.
